(19) United States
(12) Patent Application Publication
(10) Pub. No.: US 2012/0048299 A1
(43) Pub. Date: Mar. 1, 2012

(54) NOVEL CLEANING METHOD

(76) Inventors: Stephen Derek Jenkins, Cleveland (GB); William George Westwater, Yorkshire (GB)

(21) Appl. No.: 13/319,368

(22) PCT Filed: May 10, 2010
(86) PCT No.: PCT/GB10/50752

§ 371 Date: Nov. 8, 2011

(30) Foreign Application Priority Data
May 8, 2009 (GB) 0907943.5
May 10, 2010 (GB) PCT/GB2010/050752

(51) Int. Cl. B08B 3/00

(52) U.S. Cl. 134/7

(57) ABSTRACT

The invention provides a method for cleaning a soiled substrate, the method comprising the treatment of the moistened substrate with a formulation comprising a solid particulate cleaning material wherein the formulation is free of organic solvents, the treatment comprising agitation of the substrate and the formulation in at least one sealed container. Preferably the sealed container comprises a metal container or a container formed from a rigid or flexible plastic material. Preferably, the at least one container is agitated in a rotating device such as a tumble dryer. Preferably, the substrate is wetted and the solid particulate cleaning material comprises a multiplicity of polymeric particles which comprise at least one additional cleaning agent, which preferably comprises a surfactant. Most preferably, the substrate comprises a textile fibre. Typically, the polymeric particles comprise particles of nylon or polyester. The results obtained are in line with those observed when carrying out conventional cleaning processes and the method provides the significant advantage that the use of solvents, with all the attendant drawbacks in terms of cost and environmental considerations, can be avoided.

### FIELD OF THE INVENTION

The present invention relates to the cleaning of substrates using a solvent-free cleaning system which requires the use of only limited quantities of water. Most particularly, the invention is concerned with the cleaning of textile fibres by means of such a system,

### BACKGROUND TO THE INVENTION

Dry cleaning is a process of major importance within the textile industry, specifically for the removal of hydrophobic stains which are difficult to remove by traditional aqueous washing methods. However, most commercial dry cleaning systems currently employ toxic and potentially environmentally harmful halocarbon solvents, such as perchloroethylene. The use of these solvents, and the need for their storage, treatment, and/or disposal creates major effluent problems for the industry, and this inevitably increases costs.

More recently, the use of carbon dioxide as an alternative to such systems has been reported. Thus, systems which employ liquid carbon dioxide in combination with surfactants containing a CO₂-philic functional moiety have been proposed, whilst the use of more conventional surfactants in combination with supercritical carbon dioxide has also been disclosed. However, a major problem with carbon dioxide is its lower solvent power relative to other solvents. Furthermore, some of the procedures rely on the use of high pressure systems, and this is a clear disadvantage, since it presents an inherent safety risk, thereby lessening the attractiveness of the procedures.

Even more widely used are aqueous cleaning processes, which do not suffer from the disadvantages associated with the use of potentially toxic solvents or high pressure carbon dioxide systems, but still create very significant environmental difficulties in terms of the vast quantities of aqueous effluent which are generated. As a consequence, the use of these aqueous cleaning processes necessitates the development of sophisticated waste treatment systems.

The dry cleaning process, whilst being dependent on the use of solvents, does also incorporate aqueous media within the cleaning process, since fabrics and garments which are subjected to dry cleaning will inevitably contain significant amounts of water, which generally becomes entrapped therein by absorption or adsorption from the atmosphere. On occasions, further wetting of the fabrics or garments prior to dry cleaning may be desirable. However, the cleaning formulation used in conventional dry cleaning processes does not include added quantities of aqueous media therein and, in this way, dry cleaning differs from standard washing procedures. In the present invention, the cleaning process employs a cleaning formulation which is essentially free of organic solvents and requires the use of only limited amounts of water, thereby offering significant environmental benefits.

In the light of the difficulties and disadvantages associated with traditional aqueous and dry cleaning processes, the present inventors have previously devised a new approach to the problem, which allows the deficiencies demonstrated by the methods of the prior art to be overcome and provides a process for the cleaning of substrates, particularly for the cleaning of textile fibres. The method which is provided eliminates the requirement for the use of, on the one hand, potentially harmful solvents or carbon dioxide in either the liquid or supercritical state or, on the other hand, large volumes of aqueous fluids, but is still capable of providing an efficient means of cleaning and stain removal, whilst also yielding economic and environmental benefits. The process employs a cleaning formulation which is essentially free of organic solvents and requires the use of only limited amounts of water.

Thus, in WO-A-2007/128962 there is disclosed a method and formulation for cleaning a soiled substrate, the method comprising the treatment of the moistened substrate with a formulation comprising a multiplicity of polymeric particles, wherein the formulation is free of organic solvents. Preferably, the substrate is wetted so as to achieve a substrate to water ratio of between 1:0.1 to 1:5 w/w, and optionally, the formulation additionally comprises at least one cleaning material, which typically comprises a surfactant, which most preferably has detergent properties. In preferred embodiments, the substrate comprises a textile fibre and the polymeric particles may, for example, comprise particles of nylon, most preferably in the form of nylon chips.

Subsequently, the inventors addressed the issue of efficient separation of the cleaning chips from the cleaned substrate at the conclusion of the cleaning operation and, in PCT Patent Application No. PCT/GB2010/050261 disclosed an apparatus which facilitates the efficient cleaning of soiled substrates using the method of WO-A-2007/128962, but which additionally allows for the efficient separation of the substrate from the cleaning media at the conclusion of the cleaning process. The claimed apparatus provides a novel design requiring the use of two internal drums capable of independent rotation, and which finds application in both industrial and domestic cleaning processes. The apparatus comprises a casing which contains a rotatably mounted cylindrical cage concentrically located within a rotatably mounted cylindrical drum having a greater diameter than the basket, wherein the cage and the drum are concentrically located within a stationary cylindrical drum having a greater diameter than the rotatably mounted drum, wherein the casing includes access means, allowing access to the interior of the cylindrical basket, and wherein the rotatably mounted cylindrical cage and the rotatably mounted cylindrical drum are adapted to rotate independently.

However, whilst the apparatus of PCT Patent Application No. PCT/GB2010/050261 facilitates the effective and efficient cleaning of substrates, and especially of textile fibres, there are occasions, especially within a domestic context, when the availability of such a piece of apparatus may not be practical, either for logistical or financial reasons. Consequently, the inventors have now sought to provide a method, based on the method of WO-A-2007/128962, which allows for the cleaning of substrates in any situation and, most especially in a domestic context. Thus, the present invention seeks to provide a method which may be carried out by the use of standard domestic apparatus, most particularly, by the use of a domestic tumble dryer.

### SUMMARY OF THE INVENTION

Thus, according to the present invention there is provided a method for cleaning a soiled substrate, said method comprising the treatment of the moistened substrate with a formulation comprising a solid particulate cleaning material wherein said formulation is free of organic solvents, said treatment comprising agitation of said substrate and said formulation in at least one sealed container.

Said sealed container may most suitably comprise a metal or plastic container. Thus, for example, a metal container comprising a base container and an attachable lid may conveniently be used, an example being a container with a lid which is attached by a screw thread, such as a sealable dyepot. Typically, such a metal container may be formed from a metal such as aluminium or stainless steel, but may be formed from any suitable metal or metal alloy.

More preferably, however, said sealed container is formed from a plastic material, which may be either a rigid or flexible plastic material. Suitable rigid containers may come in the form of plastic containers of any suitable shape formed from polyalkylene polymers, such as polypropylene. Suitable examples of such containers include Tupperware® containers. Most preferably, however, said sealed containers comprise containers formed from flexible plastic materials, preferably flexible polyalkylene polymers, most preferably flexible polypropylene. Said flexible containers preferably come in the form of bags which may be sealed by tying, or by means of clips or other suitable attachments.

Suitable containers must be of a size which is sufficiently large so as to accommodate the substrate to be cleaned and the cleaning material, whilst still providing sufficient ullage to allow for efficient circulation and mixing of the materials when agitated during the cleaning process. Typically, allowance should be made for ullage values of at least 10% by volume, preferably at least 20% by volume, and most preferably from 30-60% by volume in order to provide for efficient mixing whilst maximising the utilisation capacity of the method. Suitable containers are, for example, polypropylene bags or sacks which, for example, may have a capacity of anything between 5 and 50 litres, generally between 20 and 30 litres.

In operation, the substrate to be cleaned and the cleaning material are placed in the at least one container which is then sealed and placed in an apparatus which can provide agitation and, preferably, heating to the system. Typically, the substrate is placed in a single container but, optionally, the substrate may be placed in a first container which is then placed inside a second container in order to achieve more efficient sealing.

In addition, the method of the invention envisages further embodiments wherein different substrates are placed in separate containers in order to provide a multiplicity of containers containing a variety of substrates. The multiplicity of containers may then be placed in a suitable apparatus in order to provide agitation. In such embodiments, the invention has the potential to provide a multiplicity of different cleaning environments—by the use of different solid particulate cleaning materials—within the same wash cycle. Similar advantages may be achieved by the use of a single container comprising multiple compartments.

Most effective cleaning is achieved when the method of the invention is carried out at elevated temperatures. Any temperature between ambient and about 98° C. may conveniently be used to perform the cleaning method but, preferably, cleaning is performed at temperatures between 30° and 90° C., more preferably between 40° and 60° C., most preferably around 60° C.

The method of the invention may, for example, be performed by mechanical rotation of the sealed containers in baths of water held at the desired temperature. Alternatively, devices such as microwave ovens may, for example be used to achieve the required results, but the most satisfactory means of performing the claimed method is by placing the at least one sealed container containing the various materials in a rotating device such as a tumble dryer, which may be raised to a suitable elevated temperature. Typically, the treatment is carried out for a period of between 10 minutes and 1 hour, preferably around 30 minutes.

The method of the invention may be used for the cleaning of any of a wide range of substrates including, for example, plastics materials, leather, paper, cardboard, metal, glass or wood. In practice, however, said method is principally used for the cleaning of substrates comprising textile fibre garments, and has been shown to be particularly successful in achieving efficient cleaning of textile fibres which may, for example, comprise either natural fibres, such as cotton, or man-made and synthetic textile fibres, for example Nylon 6,6, polyester, cellulose acetate, or fibre blends thereof.

The method of the invention may be applied to a wide variety of substrates as previously stated. More specifically, it is applicable across the range of natural and synthetic textile fibres, but it finds particular application in respect of Nylon 6,6, polyester and cotton fabrics.

Prior to treatment according to the method of the invention, the soiled substrate is moistened by wetting with water, in order to provide additional lubrication to the cleaning system and thereby improve the transport properties within the system. Thus, more efficient transfer of the at least one cleaning material to the substrate is facilitated, and removal of soiling and stains from the substrate occurs more readily. Most conveniently, the substrate may be wetted simply by contact with mains or tap water. Preferably, the wetting treatment is carried out so as to achieve a substrate to water ratio of between 2.5:1 and 0.1:1 w/w; more preferably, the ratio is between 2.0:1 and 0.8:1, with particularly favourable results having been achieved at ratios such as 1.5:1, 1.2:1 and 1.1:1. However, in some circumstances, successful results can be achieved with substrate to water ratios of up to 1:50, although such ratios are not preferred in view of the significant amounts of effluent which are generated.

The method of the invention has the advantage that, other than this aqueous treatment, it is carried out in the absence of added solvents—most notably in the absence of organic solvents—and, consequently, it shows distinct advantages over the methods of the prior art in terms of safety and environmental considerations, as well as in economic terms. However, whilst the formulation employed in the claimed method is free of organic solvents, in that no such solvents are added to the formulation, it will be understood that trace amounts of such solvents may inevitably be present in the polymeric particles, the substrate, the water, or other additives, such as cleaning materials, so it is possible that the cleaning formulations and baths may not be absolutely free of such solvents. However, such trace amounts are insignificant in the context of the present invention, since they do not have any impact on the efficiency of the claimed process, nor do they create a subsequent effluent disposal problem and the formulation is, therefore, seen to be essentially free of organic solvents.

The method of the present invention utilises a formulation for cleaning a soiled substrate, said formulation comprising a solid particulate cleaning material. Preferably, said solid particulate cleaning material comprises a multiplicity of polymeric particles. In one embodiment, said formulation may essentially consist only of said multiplicity of polymeric particles, but optionally in other embodiments said formulation additionally comprises at least one additional cleaning agent. Additional additives may be incorporated in said formulation, as appropriate.

The method of the present invention may be used for either small or large scale batchwise processes and, therefore, finds application in both domestic and industrial cleaning processes. However, it is particularly suited to small scale domestic applications.

### BRIEF DESCRIPTION OF THE DRAWINGS

Embodiments of the invention are further described hereinafter with reference to the accompanying drawings, in which:

FIG. 1 shows the stain pattern for a stain set on cotton fabric prior to washing according to the method of the invention;

FIG. 2 shows the CIE L* colour co-ordinate values for Coffee Stains after Xeros cleaning operations compared to the value obtained for a Coffee Stain from an uncleaned Xeros standard stain set.

FIG. 3 shows the CIE L* colour co-ordinate values for Grass Stains after Xeros cleaning operations compared to the value obtained for a Grass Stain from an uncleaned Xeros standard stain set.

FIG. 4 shows the CIE L* colour co-ordinate values for Ball Point Pen Stains after Xeros cleaning operations compared to the value obtained for a Ball Point Pen Stain from an uncleaned Xeros standard stain set.

FIG. 5 shows the CIE L* colour co-ordinate values for Tomato Ketchup Stains after Xeros cleaning operations compared to the value obtained for a Tomato Ketchup Stain from an uncleaned Xeros standard stain set.

FIG. 6 shows the CIE L* colour co-ordinate values for Boot Polish Stains after Xeros cleaning operations compared to the value obtained for a Boot Polish Stain from an uncleaned Xeros standard stain set.

FIG. 7 shows the CIE L* colour co-ordinate values for Lipstick Stains after Xeros cleaning operations compared to the value obtained for a Lipstick Stain from an uncleaned Xeros standard stain set.

FIG. 8 shows the CIE L* colour co-ordinate values for Vacuum Dirt Stains after Xeros cleaning operations compared to the value obtained for a Vacuum Dirt Stain from an uncleaned Xeros standard stain set.

### DESCRIPTION OF THE INVENTION

In the method according to the invention, the ratio of solid particulate cleaning material to substrate is based on a nominal “liquor ratio” in terms of a conventional dry cleaning system, with the preferred ratio being in the range of from 30:1 to 1:1 w/w, preferably in the region of from 10:1 to 1:1 w/w, with particularly favourable results being achieved with a ratio of between 5:1 and 1:1 w/w, and most particularly at around 4:1 w/w. Thus, for example, for the cleaning of 5 g of fabric, 20 g of polymeric particles, optionally coated with surfactant, would be employed.

As previously noted, the method of the invention finds particular application in the cleaning of textile fibres. The conditions employed in such a cleaning system are very much in line with those which apply to the conventional dry cleaning of textile fibres and, as a consequence, are generally determined by the nature of the fabric and the degree of soiling. Thus, typical procedures and conditions are in accordance with those which are well known to those skilled in the art, with fabrics generally being treated according to the method of the invention at, for example, temperatures of between 30° and 90° C., more preferably between 40° and 65° C., most preferably around 60° C., for a duration of between 20 minutes and 1 hour, then being rinsed in water and dried.

Most preferably, the solid particulate cleaning material comprises a multiplicity of polymeric particles. Said polymeric particles may comprise any of a wide range of different polymers. Specifically, there may be mentioned polyalkenes such as polyethylene and polypropylene, polyesters and polyurethanes, which may be foamed or unfoamed. Preferably, however, said polymeric particles comprise polyamide or polyester particles, most particularly particles of nylon, polyethylene terephthalate or polybutylene terephthalate. Said polyamides and polyesters are found to be particularly effective for aqueous stain/soil removal, whilst polyalkenes are especially useful for the removal of oil-based stains. Optionally, copolymers of the above polymeric materials may be employed for the purposes of the invention.

Whilst, in one embodiment, the method of the invention envisages the cleaning of a soiled substrate by the treatment of a moistened substrate with a formulation which essentially consists only of a multiplicity of polymeric particles, in the absence of any further additives, optionally in other embodiments the formulation employed may additionally comprise at least one additional cleaning agent. Preferably, the at least one additional cleaning agent comprises at least one surfactant. Preferred surfactants comprise surfactants having detergent properties. Said surfactants may comprise anionic, cationic and/or non-ionic surfactants. Particularly preferred in the context of the present invention, however, are non-ionic surfactants. Preferably, said at least one additional cleaning agent is mixed with said polymeric particles.

Various nylon homo- or co-polymers may be used including, but not limited to, Nylon 6, Nylon 6,6, polyethylene terephthalate and polybutylene terephthalate. Preferably, the nylon comprises Nylon 6,6 homopolymer having a molecular weight in the region of from 5000 to Daltons, preferably from 10000 to 20000 Daltons, most preferably from 15000 to 16000 Daltons. The polyester will typically have a molecular weight corresponding to an intrinsic viscosity measurement in the range of from 0.3-1.5 dl/g, as measured by a solution technique such as ASTM D-4603.

The polymeric particles are of such a shape and size as to allow for good flowability and intimate contact with the textile fibre. A variety of shapes of particles can be used, such as cylindrical, spherical or cuboid; appropriate cross-sectional shapes can be employed including, for example, annular ring, dog-bone and circular. The particles may have smooth or irregular surface structures and can be of solid or hollow construction. Particles are preferably of such a size as to have an average mass in the region of 5 to 100 mg, preferably from 10 to 30 mg. In the case of the most preferred particles, typically referred to as beads, the preferred average particle diameter is in the region of from 0.5 to 6.0 mm, more preferably from 1.0 to 5.0 mm, most preferably from 2.5 to 4.5 mm, and the length of the beads is preferably in the range from 0.5 to 6.0 mm, more preferably from 1.5 to 4.5 mm, and is most preferably in the region of from 2.0 to 3.0 mm.

The results obtained are very much in line with those observed when carrying out conventional dry cleaning procedures or domestic aqueous cleaning with textile fabrics. The extent of cleaning and stain removal achieved with fabrics treated by the method of the invention is seen to be very good, with particularly outstanding results being achieved in respect of hydrophobic stains and aqueous stains and soiling, which are often difficult to remove. The method also finds application in wash-off procedures applied to textile fibres subsequent to dyeing processes, and in scouring processes which are used in textile processing for the removal of dirt, sweat, machine oils and other contaminants which may be present following processes such as spinning and weaving. No problems are observed with polymer particles adhering to the fibres at the conclusion of the cleaning process. Furthermore, of course, as previously observed, the attendant drawbacks associated with the use of solvents in conventional dry cleaning processes, in terms of both cost and environmental considerations, are avoided, whilst the volumes of water required are significantly lower than those associated with the use of conventional washing procedures, again offering significant advantages in terms of cost and environmental benefits.

Additionally, it has been demonstrated that re-utilisation of the polymer particles is possible, and that particles can be satisfactorily re-used in the cleaning procedure although some deterioration in performance may be observed following multiple uses of the particles.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The method of the invention will now be exemplified, though without in any way limiting the scope of the invention, by reference to the following examples:

### EXAMPLES

### Example 1

Woven cotton fabric (282 gm⁻²) was stained using coffee and tomato ketchup following the methods described below:

### (i) Tomato Ketchup

Heinz® tomato ketchup was applied to the fabric with a synthetic sponge, within the confines of a 5 cm plastic template; the stained fabric was then dried at 40° C. for 30 minutes, after which the fabric was aged prior to use by storage in the dark for 4 days.

### (ii) Coffee

10 g of ASDA® Smart Price coffee powder was dissolved in 50 ml distilled water at 70° C. A 1 cm³ aliquot of the ensuing solution was applied to the fabric using a synthetic sponge, within the confines of a 5 cm plastic template; the stained fabric was then dried and aged following the procedure described for Tomato Ketchup.
Nylon 6,6 beads measuring approx. 5 mm×5 mm obtained from Invista Textiles (UK) Ltd were employed in the cleaning process.
The stained fabric was pinned to a the cotton coverslip of a 1 kg feather pillow, the latter being supplied by Johnsons Cleaners UK Ltd, and used as ballast. The stained cotton fabric/pillow composite was placed in a nylon warp knit, net bag, together with 400 cm³ of distilled water and sufficient Nylon 6,6 beads to realise bead:fabric ratios of 1:1; 5:1; 10:1, 15:1 and 20:1. The warp knit bag was sealed using polyester fabric ribbon. The sealed warp knit bag was then placed within a polypropylene bag which was also sealed using polyester fabric ribbon.
The warp knit bag and the polypropylene bag, together formed the container in which cleaning was carried out. The said container was placed in an Electrolux® Wascator TT500 tumble dryer and heated at around 70° C. for 30 minutes, after which time the cotton fabric/pillow composite was removed and the stained cotton fabric removed from the cotton pillow coverslip; all materials were allowed to dry.

### Assessment of Cleaning

The dry stained fabric was evaluated using visual assessment. Cleaned and uncleaned original fabrics were placed on a grey background under a D₆₅ light source and assessed by visual evaluation using a 1-5 scale based on the suggested scale for evaluation used by the International Fabricare Institute (IFI):

5: Stain completely removed (no visible trace)

4: Stain mostly removed

3: Stain slightly removed

2: Stain almost as original

1: Stain unchanged from original

Table 1 shows the level of stain removal achieved using various bead:fabric ratios, from which it is apparent that varying the ratio between 1:1 and 1:15 had little effect on the extent of stain removal. It is also clear that stain removal was lowest in the case of a 1:20 bead:fabric ratio, this being attributable to there being inappropriate ullage within the container to permit an adequate level of bead:fabric interchange.

TABLE 1
Effect of bead:fabric ratio upon stain removal

Stain removal/IFI grade

| | | Tomato |
|---|---|---|
| nylon bead:fabric ratio | Coffee | Ketchup |
| 1:1 | 4.1 | 4.1 |
| 5:1 | 3.9 | 4 |
| 10:1 | 4.2 | 4.2 |
| 15:1 | 4.2 | 4.1 |
| 20:1 | 2.8 | 2.8 |

### Example 2

White polyester/cotton ¾ sleeve shirts (Matalan®) were used, which had been stained by the application of vacuum cleaner dirt to the collars and cuffs.

The ballast comprised 2 cotton pillow cases obtained from EMPA Test materials.
Nylon 6,6 (101L NC-010 ZYTEL) beads obtained from Distrupol Ltd were employed in the cleaning operation, together with a detergent which comprised 2 gl⁻¹ Persil® Bio.
Three types of nylon bag were used:
A nylon bag having edges reinforced with double stitching;
a nylon net bag to which fabric tape had been applied to the edges for increased strength;
a fabric bag made from lightweight voile and also Organza.
   A Danube commercial tumble dryer, programmed using a PC running EDU Win computer software was employed for the Xeros cleaning cycle (60° C. for 10, 15, 20 or 30 minutes) and venting cycle (10μ, 15 and 20 minutes at 60° C. as well as 20 minutes at 30° C.)
   Four shirts, together with cotton ballast (total mass 1 kg) were placed in a 533 mm×813 mm polypropylene sack, together with 1 L of distilled water, 5 kg polymer beads and 2 gl⁻¹ Persil® Bio detergent. The sealed sack was placed in the Danube tumble dryer and cycled for 30 minutes at 60° C., followed by a 5 minute cooling down cycle.

### Assessment of Cleaning

The level of cleaning achieved was assessed visually using dry shirting. It was found that the dirt stains had been removed completely from the shirt samples.

### Example 3

Woven cotton fabric (194 g m⁻²) was stained using coffee and tomato ketchup following the methods described below:

### (i) Tomato Ketchup

Heinz® tomato ketchup was applied to the fabric with a synthetic sponge, within the confines of a 5 cm plastic template; the stained fabric was then dried at 40° C. for 30 minutes after which the fabric was aged prior to use, by storage in the dark for 4 days.

### (ii) Coffee

10 g of ASDA® Smart Price coffee powder was dissolved in 50 ml distilled water at 70° C. A 1 cm³ aliquot of the ensuing solution was applied to the fabric using a synthetic sponge, within the confines of a 5 cm plastic template; the stained fabric was then dried and aged following the procedure recounted for tomato ketchup.
Nylon 6,6 beads measuring approx. 5 mm×5 mm obtained from Invista Textiles (UK) Ltd were employed.
The stained fabrics were placed in a 2000 cm³ capacity polypropylene container, together with distilled water to provide a 1:2 water:fabric ratio and nylon beads to provide a 15:1 beads:fabric ratio. The container was tightly sealed and then was placed in a White Knight Sensodry Compact Model CL311/1W tumble dryer and tumbled, using the heat setting at full power for 30 minutes. At the end of this time, the fabric was removed from the container and allowed to dry in the open air.

Commercially available spot treatments were used to treat the stained fabric following the instructions provided by the respective manufacturer:
Oxi clean stain remover (Church and Dwight Co. Inc.);
d Vanishes Oxi Action White (Reckitt Benckiser Plc; applied at a concentration of ¼ of the supplied scoop in 100 cm³ of water at 50° C.);
Vanishes Oxi Action Multi (Reckitt Benckiser Plc; applied at a concentration of ¼ of the supplied scoop in 100 cm³ of water at 50° C.);
Vanish® Oxi action pre-wash spray (Reckitt Benckiser Plc);
Vanish® pre-wash stain remover with Oxi action and stain fighters (Reckitt Benckiser Plc);
Go oxygen powder (ASDA®).
   The stained fabrics which had been treated using the respective spot treatments were placed in a 2000 cm³ capacity polypropylene container and subjected to the cleaning process described above. At the end of this time, the fabric was removed from the container and allowed to dry in the open air.

### Assessment of Cleaning

The dry stained samples were evaluated using visual assessment. The cleaned and uncleaned original fabrics were placed on a grey background under a D₆₅ light source and assessed by visual evaluation using a 1-5 scale based on the suggested scale for evaluation used by the International Fabricare Institute (IFI) as detailed in Example 1.
The results in Table 2 show that stain removal was more effective using each of the commercial spot treatments in comparison to cleaning in the absence of spot treatment. The various commercial spot treatments imparted similar levels of stain removal.

TABLE 2
Stain removal achieved using various oxygen bleach-based spot treatments

Stain removal

| Spot treatment | Coffee | Ketchup |
|---|---|---|
| Interstitial cleaning process without spot | 3.5 | 3.5 |
| treatment | | |
| Vanish ® pre-wash stain remover with Oxi | 4.5 | 4.25 |
| action and stain fighters | | |
| Vanish ® oxi action multi | 5 | 4.5 |
| Oxi Clean Stain Remover | 4.75 | 4.5 |
| Vanish ® Oxi action white | 4.75 | 4.25 |
| Vanish ® oxi action pre-wash spray | 4.25 | 4.25 |
| Go oxygen powder | 4.5 | 3.5 |

### Example 4

Woven cotton fabric (194 g/m², Whaleys, Bradford, U.K.) was stained with coffee, lipstick, ball point pen, tomato ketchup, boot polish, grass and vacuum dirt following the methods described below:

### (i) Coffee

10 g of Morrisons® Full Roast coffee powder was dissolved in 50 ml distilled water at 70° C. A 1 cm³ aliquot of the ensuing solution was applied to the fabric using a synthetic sponge, within the confines of a 5 cm diameter circular plastic template; the stained fabric was then allowed to dry at ambient temperature (23° C.), after which the fabric was aged prior to use, by storage in the dark for 4 days.

### (ii) Lipstick

Revlon® Super Lustrous lipstick (copper frost shade) was applied to the fabric using a synthetic sponge to provide a uniform coverage within the confines of a 5 cm diameter circular plastic template. The fabric was then aged following the procedure recounted for coffee.
(iii) Ball Point Pen
A black Paper Mate® Flex Grip Ultra ball point pen was used to uniformly cover the fabric within the confines of a 5 cm diameter circular plastic template. The fabric was then aged following the procedure recounted for coffee.

### (iv) Tomato Ketchup

Heinz® tomato ketchup was applied to the fabric using a synthetic sponge to provide a uniform coverage within the confines of a 5 cm diameter circular plastic template. The fabric was then aged following the procedure recounted for coffee.

### (v) Boot Polish

Kiwi® black boot polish was applied to the fabric using a synthetic sponge to provide a uniform coverage within the confines of a 5 cm diameter circular plastic template. The fabric was then aged following the procedure recounted for coffee.

### (vi) Grass

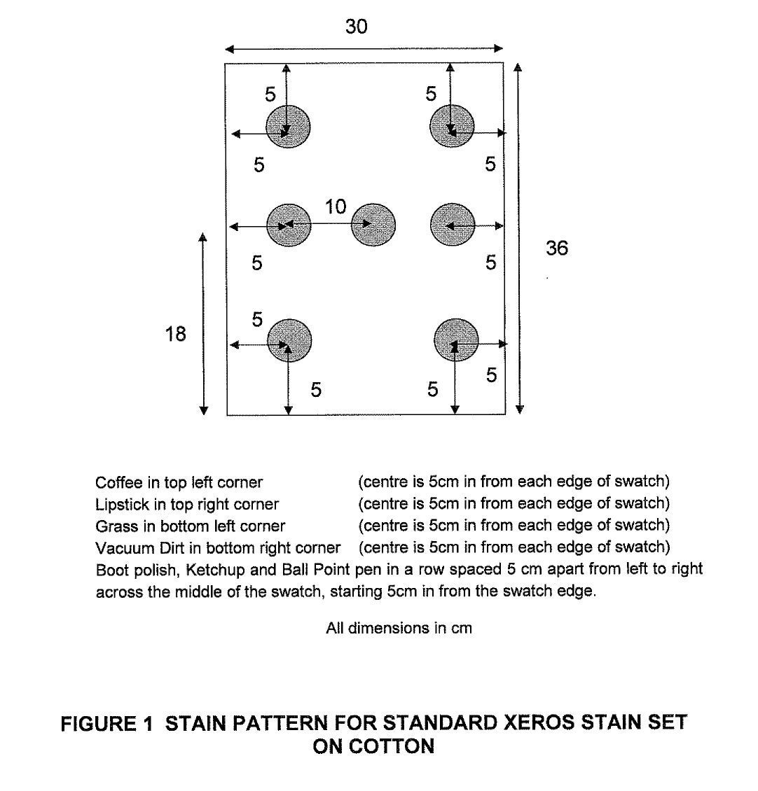

Grass was collected manually from an MG7 (National Vegetation Classification) source. 10 g of the grass was chopped with scissors and blended with 200 ml of tap water using an electronic blender. The mixture was then filtered using a metal sieve, and the filtrate used as the staining medium. This was applied to the fabric using a synthetic sponge to provide a uniform coverage within the confines of a 5 cm diameter circular plastic template. The fabric was then aged following the procedure recounted for coffee.
(vii) Vacuum Dirt
Vacuum dirt was collected manually from a general domestic vacuum bag. 25 g of vacuum dirt was mixed with 100 ml of tap water, and the mixture used to stain the fabric. This was applied to the fabric using a synthetic sponge to provide a uniform coverage within the confines of a 5 cm diameter circular plastic template. The fabric was then aged following the procedure recounted for coffee.
Each of the stains (i)-(vii) here was applied to a single (36 cm×30 cm) piece of cotton fabric in the pattern described in FIG. 1, to make up a standard Xeros stain set. Thus, the pattern was as follows:
Coffee in top left corner with centre of stain 5 cm from each edge of swatch;
Lipstick in top right corner with centre of stain 5 cm from each edge of swatch;
Grass in bottom left corner with centre of stain 5 cm from each edge of swatch;
Vacuum Dirt in bottom right corner with centre of stain 5 cm from each edge of swatch; and
Boot Polish, Ketchup and Ball Point Pen in a row spaced 5 cm apart from left to right across the middle of the swatch, starting 5 cm from the swatch edge.
   Nylon 6,6 (101L NC-010 ZYTEL) beads obtained from Distrupol Ltd were employed in the cleaning operation.
   The washload comprised 4 cotton pillowcases obtained from EMPA Test Materials used as ballast, plus two standard Xeros stain sets as described above. The total dry washload mass was then 1 kg.
   This washload was placed in a 533 mm×813 mm polypropylene sack, together with 1 L of tap water, 5 kg polymer beads and 4 g/l Persil® Bio detergent. The sealed sack was placed in the Danube tumble dryer and cycled for 30 minutes at 60° C., followed by a 5 minute cooling down cycle.
   This process was repeated 100 times using a new washload each time, but the same sample of beads. There was no separate cleaning of the beads between washes.
   The Xeros standard stain sets were line dried at ambient temperature (23° C.) after each wash, prior to analysis.

### Assessment of Cleaning

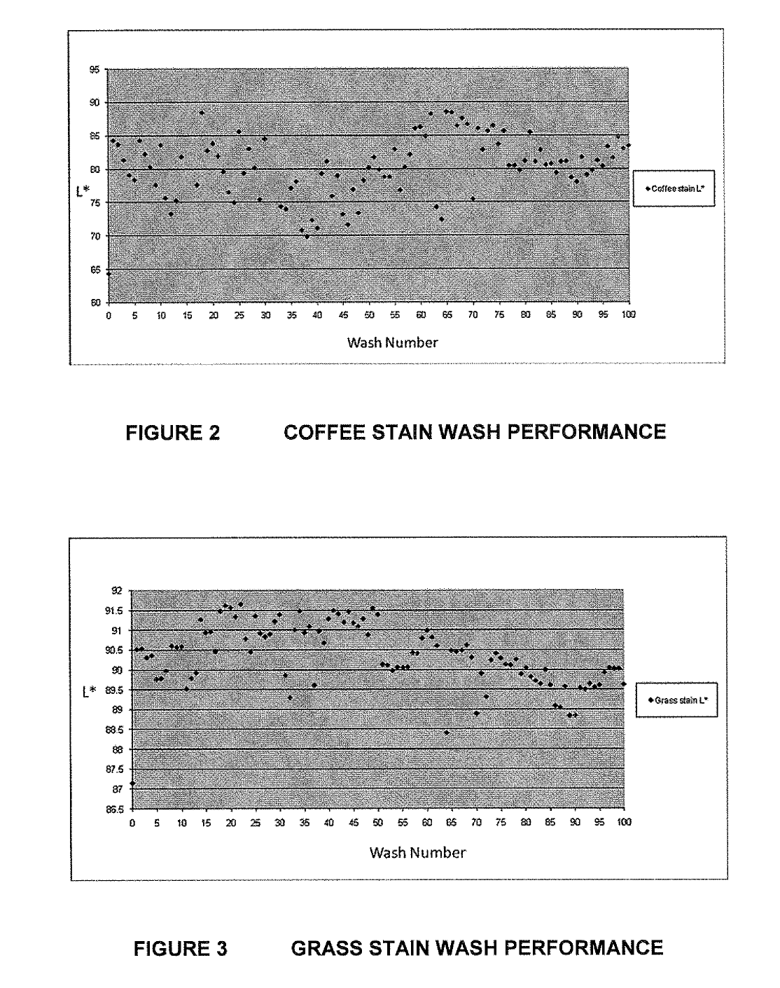

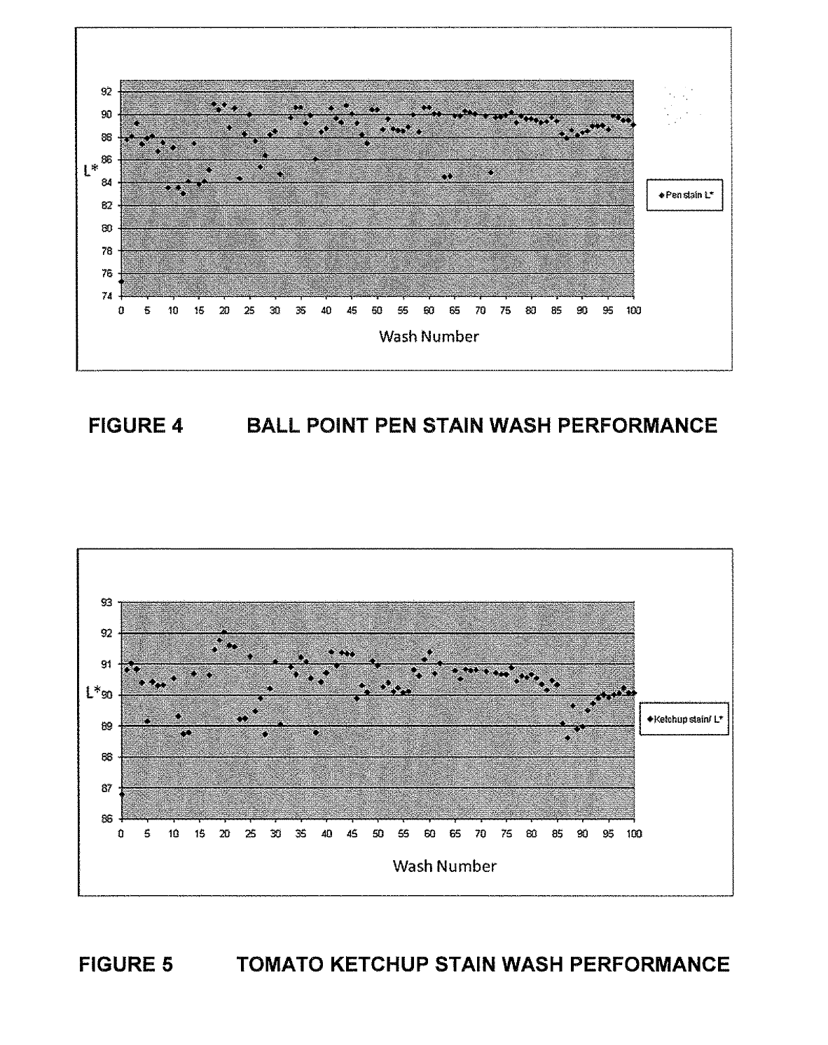

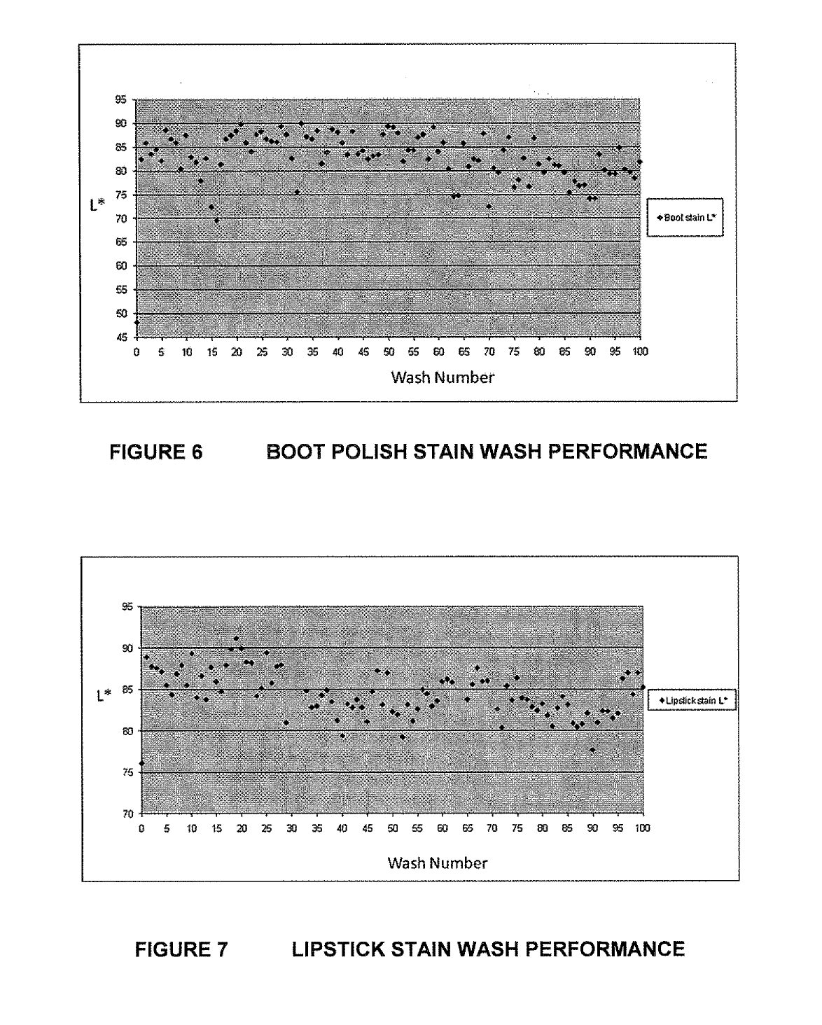

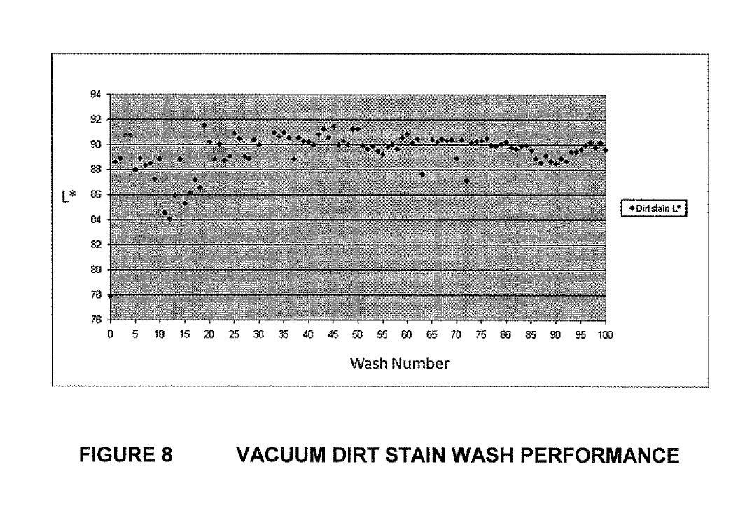

The level of cleaning achieved was assessed using colour measurement. Reflectance values of samples were measured using a Datacolor Spectraflash SF600 spectrophotometer interfaced to a personal computer, employing a 10° standard observer, under illuminant D₆₅, with the UV component included and specular component excluded; a 3 cm viewing aperture was used. Measurements using a single thickness of fabric were made. The CIE L* colour co-ordinate was taken and the results are set out in FIGS. 2-8. As a control the same measurement was taken for all seven stains used on an uncleaned Xeros standard stain set for comparison (marked as wash 0 in FIGS. 2-8 respectively).
It is observed that FIGS. 2-8 show significant increases in L* (and hence good stain removal) after Xeros cleaning, compared to the unwashed stain for all stain types, and across all 100 washes run.

1.-67. (canceled)

68. A method for cleaning a soiled substrate, said method comprising a batchwise process for the treatment of the moistened substrate with a formulation comprising a solid particulate
cleaning material wherein said formulation is free of organic solvents, said treatment comprising agitation of said substrate and said formulation in at least one sealed container, wherein said container provides an ullage value of at least 10% by volume.

69. A method as claimed in claim 68 wherein said sealed container comprises a metal or plastic container.

70. A method as claimed in claim 69 wherein said container is formed from a rigid or flexible plastic material, wherein said rigid plastic container is optionally formed from a polyalkylene polymer and said flexible plastic container is optionally formed from a polyalkylene polymer and optionally comprises a bag which is sealed by tying or by means of a clip or other attachment.

71. A method as claimed in claim 70 wherein said container comprises a polypropylene bag or sack having a capacity of between 5 and 50 litres.

72. A method as claimed in claim 68 wherein said ullage value is at least 20% by volume.

73. A method as claimed in claim 72 wherein said ullage value is from 30-60% by volume.

74. A method as claimed in claim 68 wherein said at least one container comprises a single container, wherein said single container optionally comprises multiple compartments.

75. A method as claimed in claim 68 wherein said substrate is placed in a first container which is then placed inside a second container.

76. A method as claimed in claim 68 wherein said container is agitated in a rotating device, wherein said rotating device optionally comprises a tumble dryer.

77. A method as claimed in claim 68 wherein said substrate comprises a textile fibre.

78. A method as claimed in claim 77 wherein said textile fibre comprises a natural fibre, which optionally comprises cotton, or said textile fibre comprises a synthetic fibre, which optionally comprises Nylon 6,6 or a polyester.

79. A method as claimed in claim 68 wherein said substrate is wetted by contact with mains or tap water so as to achieve a substrate to water ratio which is optionally between 2.5:1 and 0.1:1 w/w.

80. A method as claimed in claim 68 wherein said solid particulate cleaning material comprises a multiplicity of polymeric particles, wherein said polymeric particles optionally comprise particles of polyalkenes, polyurethanes, polyamides or polyesters, or copolymers thereof, and said polymeric particles optionally have an average mass in the region of from 5 to 100 mg.

81. A method as claimed in claim 80 wherein said polyamide particles comprise nylon beads, optionally comprising Nylon 6 or Nylon 6,6, wherein said Nylon 6,6 is optionally a homopolymer having a molecular weight in the region of from 5000 to 30000 Daltons.

82. A method as claimed in claim 80 wherein said polyester particles comprise particles of polyethylene terephthalate or polybutylene terephthalate, wherein said polyester optionally has a molecular weight corresponding to an intrinsic viscosity measurement in the range of from 0.3-1.5 dl/g as measured by ASTM D-4603.

83. A method as claimed in claim 80 wherein said polymeric particles are optionally have an average particle diameter in the region of from 0.5 to 6.0 mm and wherein the length of said cylindrical particles is optionally in the range of from 0.5 to 6.0 mM.

84. A method as claimed in claim 68 wherein said formulation comprises at least one additional cleaning agent, wherein said at least one additional cleaning agent optionally comprises at least one surfactant having detergent properties, and wherein said surfactant comprises at least one anionic, cationic and/or non-ionic surfactant.

85. A method as claimed in claim 84 wherein said at least one additional cleaning agent is mixed with said solid particulate cleaning material, wherein the ratio of said solid particulate cleaning material to textile fibre is optionally in the range of from 30:1 to 0.1:1 w/w.

86. A method as claimed in claim 68 herein said treatment is carried out at a temperature of between ambient and 98° C.

87. A method as claimed in claim 86 wherein said treatment is carried out for a duration of between 10 minutes and 1 hour.
